(19) United States
(12) Patent Application Publication
(10) Pub. No.: US 2016/0008979 A1
(43) Pub. Date: Jan. 14, 2016

(54) METHOD FOR CHECKING A ROBOT PATH

(71) Applicant: ABB TECHNOLOGY AG, Zürich (CH)

(72) Inventor: Rene Kirsten, Fernwald (DE)

(21) Appl. No.: 14/772,453

(22) PCT Filed: Mar. 7, 2013
(86) PCT No.: PCT/EP2013/000661

§ 371 Date: Sep. 3, 2015

(51) Int. Cl. B25J 9/16

(52) U.S. Cl. CPC B25J 9/1676; Y10S 901/02; Y10S 901/06

(57) ABSTRACT

A method checks a robot having a robot controller having a predeterminable safety range, wherein the robot can interrupt the travelling of the robot tool center point (TCP) into the safety range if the robot tool center point (TCP) travels into the safety range during execution of a movement program. The method involves: fixing a safety range which is surrounded by boundary surfaces spanned between respective boundary points, predetermining the safety range on the robot controller, if the safety range is not yet predetermined, fixing a test movement path which in principle lies outside the safety range having a plurality of path points, wherein at least one path point is located in the immediate vicinity of one of the boundary surfaces, executing a test movement program by moving the TCP along the test movement path, checking whether the execution of the test movement program is interrupted.

### CROSS-REFERENCE TO RELATED APPLICATIONS

This application is a U.S. national stage application under 35 U.S.C. § 371 of International Application No. PCT/EP2013/000661, filed on Mar. 7, 2013. The International Application was published in German on Sep. 12, 2012, as WO 2014/135175 A1 under PCT Article 21(2).

### FIELD

The invention relates to a method for checking a robot having a robot controller and having a predeterminable safety range.

### BACKGROUND

It is generally known that robots are used in industrial plants for diverse purposes, for example for assembly, welding or else painting. A robot of this type is customarily controlled by means of a robot controller. A robot controller typically has properties of a computation device and is therefore provided to bring about a movement of the robot or of the tool center point (TCP) thereof as planned on the basis of the data stored in a movement program. A movement program therefore also comprises the coordinates of a movement path, along which the TCP is intended to be moved as planned. Path points which lie on the movement path and which, sequentially interconnected, then produce the movement path are customarily predetermined in this connection.

Robots are frequently designed as “articulated-arm robots” which have, for example, a working range of 2-3.5 m about a rotatably mounted base and have 5, 6 or else 7 degrees of freedom of movement with a corresponding number of movement axes. In order to prevent individuals remaining within the working range of the robot from being put at risk, robots or the robot controllers generally have a safety functionality. One possibility for ensuring the safety of individuals consists in a safety range, into which the robot may not be moved under any circumstances, being predetermined for the robot or for the robot controller thereof. Any movement of the robot or of the TCP thereof into the safety range customarily immediately results in the robot being switched off at once. It is thus possible for individuals to be able to remain in the safety range without any risk. The current position of the robot or of the TCP thereof is determined, for example, via a determination of the angular position of the respective movement axes and a retrospective geometrical calculation.

For safety reasons, it is provided, in the case of some robots, to define the TCP on the basis of a contour region which envelops a tool which is fastened to the tip of the robot arm, for example a gripping tool. In this case, not only entry of the TCP into the safety range, but even entry of at least one point of the enveloping contour region will lead to the robot being switched off.

During the commissioning of a robot, it proves difficult to verify the correct interaction of safety zone and a movement program. A robot program provided for the production should be designed specifically such that conflict of the robot movements with a safety range is avoided such that protection triggering, i.e. breaking off of a movement program, does not occur either. Furthermore, it has to be checked whether the planned safety range has been correctly configured in the safety control system of the robot controller. For example, in order to simulate a correct operation, the boundary points of a protection range have been arrived at manually and the extent to which the setting of the protection range coincides with the boundary conditions provided has been verified.

### SUMMARY

An aspect of the invention provides a method for checking a robot, the robot including a robot controller and a predeterminable safety range, and the robot being configured to interrupt entry of a tool center point (TCP) of the robot into the safety range if the entry occurs while executing a movement program, the method comprising: determining the safety range, which is enclosed by boundary surfaces fixed between respective boundary points; predetermining the safety range on the robot controller if the safety range has not yet been predetermined; determining a test movement path which in principle lies outside the safety range and includes a plurality of path points, at least one path point being located in an immediate vicinity of one of the boundary points; executing a test movement program by moving the TCP along the test movement path; and checking whether execution of the test movement program is interrupted.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows an exemplary robot having a working and safety range;

FIG. 2 shows an excerpt from a first exemplary test movement path;

FIG. 3 shows an excerpt from a second exemplary test movement path;

FIG. 4 shows an excerpt from a third exemplary test movement path;

FIG. 5 shows an excerpt from a fourth exemplary test movement path; and

FIG. 6 shows a robot with robot controller and computation device.

### DETAILED DESCRIPTION

Starting from the background, an aspect of the invention provides a method with which precise checking of a safety range and the interaction during the execution of a movement program can be checked.

An aspect of the invention provides a method for checking a robot having a robot controller and having a predeterminable safety range, wherein the robot is provided to interrupt the entry of the tool center point (TCP) of the robot into the safety range in the event of said entry taking place during the execution of a movement program. The method comprises the following steps:
determining at least one safety range which is enclosed by boundary surfaces fixed between respective boundary points,
predetermining the at least one safety range on the robot controller if said safety range has not yet been predetermined,
determining a test movement path which in principle lies outside the at least one safety range and has a plurality of path points, wherein at least one path point is located in the immediate vicinity of one of the boundary points,
executing a test movement program by moving the TCP along the test movement path,
checking whether the execution of the test movement program is interrupted.

An aspect of the invention includes developing one or, if required, also more test movement programs which, with regard to the reference coordinate system, have been compared with a previously determined safety region and which specifically comprise one, but preferably more boundary points, by means of which the safety range is defined, as path points. In this way, during the execution of the test program, specifically those points of the working range of the robot which are the most relevant in respect of a possible interruption of a movement program because of an infringement of the safety range are approached. However, in order to avoid possible mistriggerings, the coordinates of the boundary points are not precisely approached, but rather a tolerance range of, for example, within the range of 0.1 mm to 25 mm is generally placed around a respective boundary point, which tolerance range should be understood under “immediate vicinity” within the scope of this view. However, an even greater tolerance range can absolutely also be understood by this term.

The TCP of the robot is then moved according to the test movement program to respective spatial coordinates which lie outside the safety region, but are at a distance, corresponding to the tolerance range, from a respective boundary point or also from the respective boundary surfaces defining the protection range. It is thereby ensured that, even if the path points are approached along a worn path, entry of the TCP into the protection range and an associated mistriggering are avoided. However, wear of the movement path is very low, in particular at very low speeds of movement of the TCP, and therefore the tolerance range around a boundary point can also be selected to be very small and, in the extreme case, even zero.

In the event of a contour region being defined around the TCP, which contour region envelops, for example, a welding or gripping tool mounted on the robot, a movement program is already interrupted, as described at the beginning, if a single point of the contour region is located in the safety zone. In order to take this into account, it is provided according to the invention that, in the event of a defined contour region, instead of the actual TCP describing the programmed movement path, that point of the enveloping surface of the contour region which, taking into consideration the current robot position, is at the shortest distance from a respective boundary point of the safety range should be regarded as the reference point. A respective path point is therefore determined in the immediate vicinity of a boundary point in such a manner that it is not the actual TCP or path point which lies in the immediate vicinity of the boundary point, but rather the point of the enveloping surface at the smallest distance from the respective boundary point. Since the principle on which the invention is based is unaffected by a possible contour region, the term “TCP” is used below for both variants, namely the actual TCP as reference point or that point on the enveloping surface of a contour region at the shortest distance from the respective boundary point.

It furthermore proves advantageous that, by means of the sequential approach of the respective boundary points, even if this takes place taking a tolerance range into consideration, the boundaries of the protection range are readily visualized. During the commissioning of a robot system, this enables a repeated visual check as to whether the safety range has been correctly determined or whether said safety range proves suitable.

Insofar as the test movement program, upon execution thereof, does not result in any emergency triggering, it can be assumed, because of the immediate vicinity of the movement path of the test movement program to the boundary region of the safety range, that the protection system is operating in a manner free from error insofar as no mistriggering occurs outside the protection range. The protection range of a robot can thereby be verified in a particularly simple manner.

According to a further preferred variant embodiment of the method according to the invention, in the event of an interruption of the test program, the TCP of the robot is then moved to one of the path points and the test movement program is then continued.

This advantageously permits a repetition of the robot movement within the scope of an interruption which may have taken place, namely if the TCP of the robot is moved back to one of the path points already passed and the test movement program is continued again from there. It can therefore be checked whether the interruption of the movement program does or does not involve a reproducible effect. Reproducibility of the interruption behavior of a robot during the execution of a movement program is likewise a criterion for correct and reliable operation of the robot.

In the event that, after an interruption, the TCP is moved forward to one of the path points not yet passed, the test movement program can advantageously be continued from there, and therefore possible further interruptions of the movement program at another point of the test movement path can likewise be ascertained.

According to a particularly preferred refinement of the method according to the invention, in a deviation, at least one portion of the test movement path lies within the safety range. The background for a conscious partial protrusion of the test movement path into the safety range is that active triggering of the protection system can thus be verified. Ideally, however, in this case, the relevant path points lying within the safety range are also in the immediate vicinity of a respective boundary point determining the safety range. The extent to which an even slight infringement of the safety range leads to the then desirable interruption of the test movement program can therefore be checked. However, even a path portion guided as desired through the safety range must, of course, lead to an interruption of the test movement program during correct operation.

It is also true of this variant of the invention that, after an interruption of the test movement program has taken place, the TCP of the robot can be moved to one of the path points and the test movement program is then continued from there. This therefore also results in the possibility here of reproducing a triggering which has taken place or else of checking the extent to which further triggerings take place during the further program sequence.

According to another variant of the method according to the invention, the test movement path is determined by means of a separate computation device on the basis of suitable algorithms and the data of the test movement path are then made available to the robot controller. The computation device is equipped, for example, with a software program product which permits a simulation of the working environment, for example a CAD program. This advantageously simplifies a development of a corresponding test movement program that optionally takes place manually, but, of course, can also take place automatically. At least for the determining of the at least one path point in the immediate vicinity of one of the boundary points of the safety range, the corresponding algorithms require the coordinates of said safety range and optionally the relative coordinates of a contour region. It is therefore provided, in a variant of the invention, that, before the test movement path of the test movement program is determined, safety-relevant data, namely in particular the coordinates of the boundary points of the safety range and optionally the relative coordinates of a contour region, are transmitted from the robot controller to the separate computation device.

However, it is also possible, according to an alternative variant, to determine the safety range in the separate computation device itself, then to develop a test movement program on the basis of said data and then to transmit both the coordinates of the boundary points of the safety range and the test movement program, or at least the test movement path, to the robot controller.

During the determination of the path points, the suitable algorithms take into consideration at least one, but preferably more of the boundary points defining the safety range, wherein the respective path point is displaced away from the safety range by a tolerance value in comparison to the respective boundary point.

It is also provided, according to a further variant of the invention, that the test movement path is determined by means of the robot controller itself on the basis of suitable algorithms. In a known manner, said robot controller should likewise be considered to be a computation device which is suitable for defining a test movement path on the basis of suitable algorithms. In this case, however, the use of a simulation program can be dispensed with; on the contrary, a computer program product which, on the basis of a preferably predetermined starting or end point using the coordinates of at least one of the boundary points, generates a test movement path, can be provided. A user interface, by means of which basic specifications for generating the test program path can be input, is optionally provided.

According to a furthermore preferred variant of the invention, data of possible interfering contours within the working range of the robot are additionally made available to the separate computation device or to the robot controller to determine the test movement path, and the test movement path is determined on the basis of the algorithms in such a manner that a collision with an interfering contour is avoided. This relates in particular to the working range of the robot. Path portions which lead, for example, from a starting point within the working range as far as into the immediate vicinity of one of the boundary points, but in which a collision with an object located in-between can be anticipated, are therefore reliably bypassed, for example, by means of a U-shaped path profile. A collision is therefore avoided in an advantageous manner.

According to a particularly preferred variant of the invention, the robot has a TCP home position and the test movement path begins at the TCP home position and/or ends there. A home position of this type should preferably be selected in such a manner that rapid reachability in particular of the predominant number of boundary points is ensured from there.

Following a preferred variant of the invention, the safety range is cuboidal or has the shape of a plurality of fitted-together cuboids. This proves particularly simple for determining the safety range.

According to a further variant of the method according to the invention, the test movement path comprises at least a predominant portion of the boundary points of the safety range, which boundary points face the robot, as path points in a respective tolerance range. The boundary points facing the robot namely define that part of the boundary surface of the safety range through which the TCP of the robot coming from the working range could penetrate. By contrast, the rear region of the boundary surface is not of importance for checking the robot behavior insofar as the robot would penetrate the boundary surface coming from the safety range in such a case, and the respective movement program would have to be interrupted even as the TCP enters the safety range.

Further advantageous refinement possibilities can be gathered from the further dependent claims.

The invention, further embodiments and further advantages are intended to be described in more detail with reference to the exemplary embodiments illustrated in the drawings.

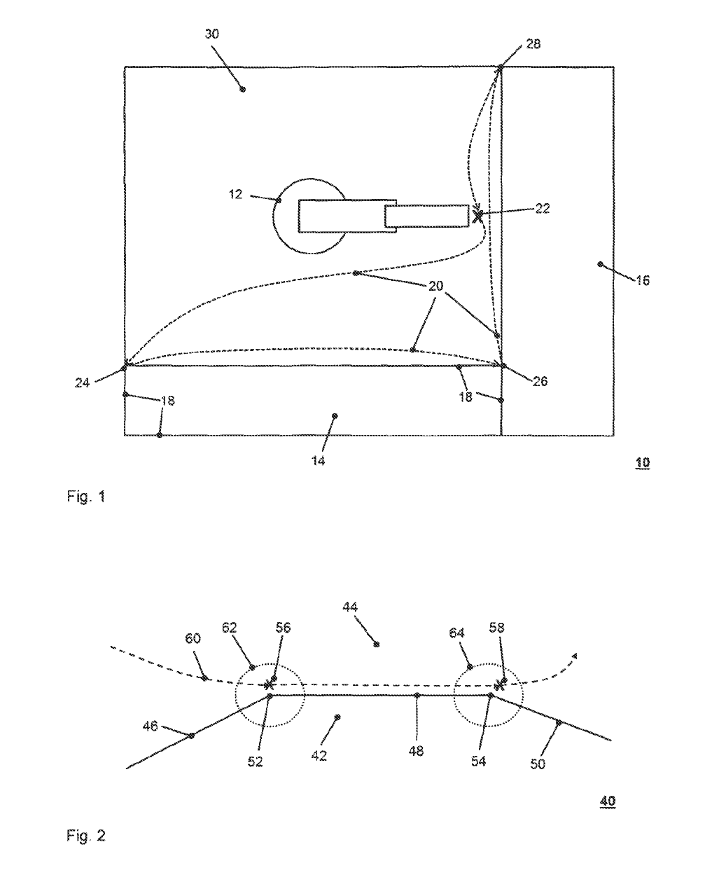

FIG. 1 shows, in a schematic drawing 10, an exemplary robot 12 having a working range 30 and safety range 14, 16. The robot 12 is located within the working range 30, wherein the TCP of said robot has taken up a home position 22 in the figure, from which a test movement path 20 of an exemplary test movement program starts and also ends there.

In this exemplary two-dimensional illustration, the test program comprises all of the boundary points of the safety range 14, 16, which boundary points face the robot 12 and are incorporated into the test movement path 20 as path points 24, 26, 28, taking a corresponding tolerance range into consideration. The test movement path 20 is traveled along by the TCP of the robot 12 during execution of the test movement program, wherein, in this example, all of the path points 22, 24, 26, 28 lie outside the safety range 14, 16 and, accordingly, there should also not be an interruption of the program sequence because of infringement of the protection range. In an actual three-dimensional case, the safety ranges 14, 16 would then be cuboidal and then correspondingly more boundary points would be approached.

FIG. 2 shows an illustration 40 of a first exemplary test movement path 60 which runs within the working range 44 of a robot, but in the immediate vicinity of respective boundary surfaces 46, 48, 50 of a safety range 42. Respective tolerance or proximity ranges 62, 64 are indicated by dashed circles around respective boundary points 52, 54 bounding the safety range 42. Path points 56, 58, by means of which the profile of the test movement path 60 is determined, are indicated by a cross in the respective proximity ranges 62, 64. In the ideal case, the TCP of a robot (not shown) is moved along the test movement path 60 within the proximity range of the fixed boundary surfaces, wherein said TCP does not penetrate the safety range and also the associated movement program is not interrupted.

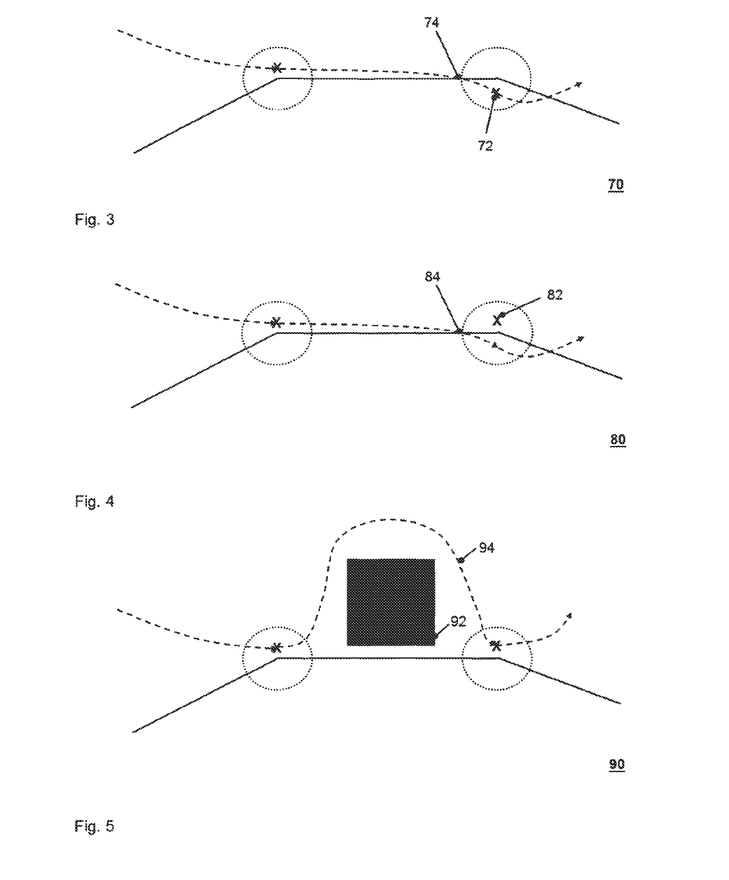

FIG. 3 shows, in an illustration 70, a similar profile of a test movement path, wherein an associated path point 72 within the safety range is provided within the proximity range of the boundary point shown on the right in the figure. In the region of an entry point 74, the profile of the test movement path intersects a boundary surface enclosing the safety range. When a robot or robot controller works correctly, an anticipated interruption of the test movement program would have to be initiated at the entry point 74.

FIG. 4 in turn shows, in an illustration 80, a profile of a test movement path in the vicinity of respective boundary surfaces enclosing a safety range. The desired path profile is predetermined by respective path points which are all arranged in the immediate vicinity of the respective boundary points, but within the working range, as indicated by the path point having the reference number 82. The actual path profile deviates from the desired path profile insofar as entry into the safety range takes place in the region of an entry point 84. When the robot or robot controller works correctly, an unexpected interruption of the test movement program would have to be initiated at the entry point 84. This is a sign that the robot is not guiding the TCP in a manner true to the path and the robot concerned should not be put into operation.

FIG. 5 shows, in an illustration 90, a profile of a further test movement path which, however, is guided around an interfering contour 92 in a bypass 94 such that a collision of the robot with the interfering contour is avoided.

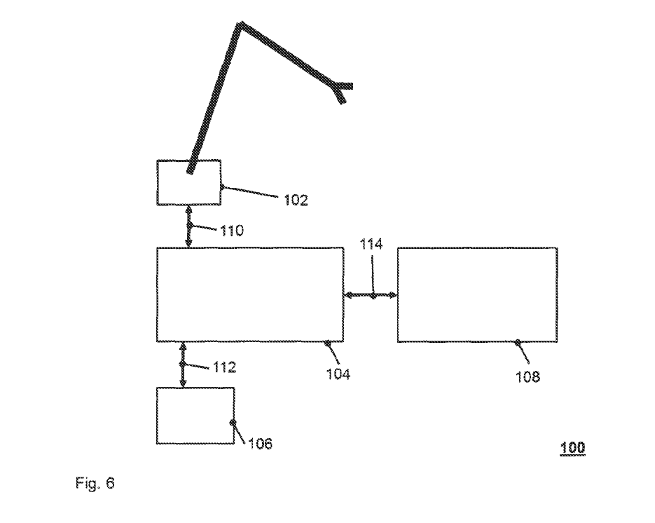

FIG. 6 shows, in a schematic diagram 100, a structural image of a robot 102 with robot controller 104 and computation device 108. Said components are connected to each other via communication and control lines 110, 114, wherein a manual input device interacts with the robot controller 104 by means of a communication and control line 112 and thus permits interaction of an operator with the system shown.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

### LIST OF REFERENCE NUMBERS

10 Exemplary robot having a working and safety range
12 Exemplary robot
14 First cuboid-like safety range
16 Second cuboid-like safety range
18 Fixed boundary surfaces
20 Test movement path
22 TCP home position
24 First path point of test movement path
26 Second path point of test movement path
28 Third path point of test movement path
30 Working range
40 Excerpt from first exemplary test movement path
42 Safety range
44 Working range
46 First fixed boundary surface
48 Second fixed boundary surface
50 Third fixed boundary surface
52 First boundary point
54 Second boundary point
56 First path point of first exemplary test movement path
58 Second path point of first exemplary test movement path
60 First exemplary test movement path
62 Proximity range around first boundary point
64 Proximity range around second boundary point
70 Excerpt from second exemplary test movement path
72 Path point lying within the safety range
74 Planned entry point into safety range
80 Excerpt from third exemplary test movement path
82 Path point lying within the safety range
84 Unplanned entry point into safety range
90 Excerpt from fourth exemplary test movement path
92 Exemplary interfering contour
94 Bypass of the interfering contour
100 Robot with robot controller and computation device
102 Robot
104 Robot controller
106 Manual input device
108 Computation device
110 Communication/control line
112 Communication/control line
114 Communication/control line

1. A method for checking a robot, the robot including a robot controller and a predeterminable safety range, and the robot being configured to interrupt entry of a tool center point (TCP) of the robot into the safety range if the entry occurs while executing a movement program, the method comprising:
determining the safety range, which is enclosed by boundary surfaces fixed between respective boundary points;
predetermining the safety range on the robot controller if the safety range has not yet been predetermined;
determining a test movement path which in principle lies outside the safety range and includes a plurality of path points, at least one path point is being located in an immediate vicinity of one of the boundary points;
executing a test movement program by moving the TCP along the test movement path; and
checking whether execution of the test movement program is interrupted.

2. The method of claim 1, further comprising, in the event of an interruption of the test program: moving the TCP of the robot to one of the path points; and, then, continuing the test movement program.

3. The method of claim 1, wherein, in a deviation, at least one portion of the test movement path lies within the safety range.

4. The method of claim 3, wherein at least one of the path points lies within the safety region in the immediate vicinity of a respective limit point.

5. The method of claim 1, comprising:
determining the test movement path using a separate computation device based on suitable algorithms; and, then,
making data of the test movement path are then made available to the robot controller.

6. The method of claim 5, further comprising, before the determining of the test movement path:
transmitting safety-relevant data from the robot controller to the separate computation device.

7. The method of claim 1, wherein the test movement path is determined using the robot controller based on suitable algorithms.

8. The method of claim 5, further comprising:
making available data of possible interfering contours within the working range of the robot to the separate computation device to determine the test movement path; and
determining the test movement path based on algorithms so as to avoid a collision with an interfering contour.

9. The method of claim 1, wherein the robot includes a TCP home position, and
wherein the test movement path starts, ends, or starts and ends at the TCP home position.

10. The method of claim 1, wherein the safety range is cuboidal.

11. The method of claim 10, wherein the test movement path includes a predominant portion of the boundary points of the safety range, and
wherein the boundary points face the robot, as path points in a respective tolerance range.

12. The method of claim 5, further comprising:
making available data of possible interfering contours within the working range of the robot to the robot controller to determine the test movement path; and
determining the test movement path based on algorithms so as to avoid a collision with an interfering contour.

13. The method of claim 9, wherein the test movement path starts at the TCP home position.

14. The method of claim 9, wherein the test movement path ends at the TCP home position.

15. The method of claim 9, wherein the test movement path starts and ends at the TCP home position.

16. The method of claim 1, wherein the safety range has a shape of a plurality of fit-together cuboids.
